(19) United States
(12) Patent Application Publication
(10) Pub. No.: US 2026/0085987 A1
(43) Pub. Date: Mar. 26, 2026

(54) PRESSURE SENSORS, AND METHODS OF ASSEMBLING PRESSURE SENSORS, FOR DYNAMIC, HIGH PRESSURE, HYDRAULIC SYSTEMS

(71) Applicant: ILLINOIS TOOL WORKS INC., Glenview, IL (US)

(72) Inventors: Richard Alan Meyer, Chaska, MN (US); Riley August Rogotzke, Chanhassen, MN (US); Alex Langseth, Eden Prairie, MN (US); Stephen Zachman, St. Louis Park, MN (US); David Allen Pankratz, Eden Prairie, MN (US)

(21) Appl. No.: 19/332,286

(22) Filed: Sep. 18, 2025

Related U.S. Application Data
(60) Provisional application No. 63/698,932, filed on Sep. 25, 2024.
(60) Provisional application No. 63/765,234, filed on Feb. 28, 2025.

(51) Int. Cl. G01L 9/00; G01L 19/00; G01L 19/14

(52) U.S. Cl. CPC G01L 9/0027; G01L 19/0084; G01L 19/143; G01L 19/147

(57) ABSTRACT

Described herein are examples of pressure sensors, and methods to assemble pressure sensors. In some examples, a pressure sensor uses gauges attached to a sensor tube of a sensor body to detect a pressure of fluid flowing within the sensor tube. In some examples, the sensor tube helps to isolate the gauges from some of the stresses that the rest of the sensor body may experience due to intense fluid pressures. In some examples, the sensor body has a one piece design that increases durability. In some examples, a sensor adapter may be attached to the sensor body and/or hardened by one or more techniques to reduce the chance of fluid leakage and/or further increase durability. The gauges, the sensor body, and/or the sensor adapter can be enclosed within a sensor cover, and encased within a potting material, to protect and/or insulate the components.

### CROSS REFERENCE TO RELATED APPLICATIONS

This application claims priority to, and the benefit of, U.S. Provisional Patent Application No. 63/698,932 , filed Sep. 25, 2024, entitled “Pressure Sensors for Dynamic, High Pressure, Hydraulic Systems,” and U.S. Provisional Ser. No. 63/765,234 , filed Feb. 28, 2024, entitled “Methods of Assembling Pressure Sensors for Dynamic, High Pressure, Hydraulic Systems,” both of which are hereby incorporated by reference in their entirety.

### TECHNICAL FIELD

The present disclosure generally relates to pressure sensors, and methods of assembling pressures sensors, configured for dynamic, high pressure, hydraulic systems.

### BACKGROUND

Pressure sensors measure a pressure of a fluid (e.g., air, gas, liquid, etc.). The pressure measurements may be used for a variety of different purposes and/or applications.

Limitations and disadvantages of conventional and traditional approaches will become apparent to one of skill in the art, through comparison of such systems with the present disclosure as set forth in the remainder of the present application with reference to the drawings.

### BRIEF SUMMARY

The present disclosure is directed to high output pressure sensors, and/or methods of assembling high output pressures sensors, configured for employment in dynamic, high pressure, hydraulic systems, substantially as illustrated by and/or described in connection with at least one of the figures, and as set forth more completely in the claims.

These and other advantages, aspects and novel features of the present disclosure, as well as details of an illustrated example thereof, will be more fully understood from the following description and drawings.

### BRIEF DESCRIPTION OF THE DRAWINGS

FIG. 1 shows an example hydraulic system, in accordance with aspects of this disclosure.

FIGS. 2a-2e show different views of an example pressure sensor that might be used in the example hydraulic system of FIG. 1, in accordance with aspects of this disclosure.

FIG. 3 shows an example sensing circuit that might be used in the pressure sensor of FIG. 2, in accordance with aspects of this disclosure.

FIGS. 4a-4b show an example of an alternative sensor body that might be used in the example pressure sensor of FIGS. 2a-2e, in accordance with aspects of this disclosure.

FIG. 5 shows an example method for assembling a pressure sensor, in accordance with aspects of this disclosure.

The figures are not necessarily to scale. Where appropriate, the same or similar reference numerals are used in the figures to refer to similar or identical elements. For example, reference numerals utilizing lettering (e.g., strain gauge 298a, strain gauge 298b) refer to instances of the same reference numeral that does not have the lettering (e.g., strain gauges 298).

### DETAILED DESCRIPTION

Some examples of the present disclosure relate to pressure sensors, and/or methods of assembling pressures sensors, that are especially suited for dynamic, high pressure, hydraulic systems. In some examples, a pressure sensor uses variable resistor strain gauges attached to a sensor tube of a sensor body to detect a pressure of fluid flowing within the sensor tube. In some examples, the sensor tube helps to isolate the strain gauges from some of the bowing/bending stresses that the rest of the sensor body may experience due to the intense fluid pressures. In some examples, the sensor body has a one piece design, which increases the durability of the pressure sensor and/or its ability to withstand the stresses that come from working with intense fluid pressures.

Some examples of the present disclosure relate to a hydraulic system, comprising: a pressure sensor, the pressure sensor comprising: a sensor cover; a sensor body positioned within the sensor cover, the sensor body comprising: a sensor base, a sensor tube connected to the sensor base and extending away from the sensor base to a sensor tube end, and a sensor fluid conduit extending through the sensor base and into the sensor tube, the sensor fluid conduit being in fluid communication with the fluid volume, and the sensor tube being configured to experience a deflection in response to a fluid pressure within the sensor fluid conduit, a circuit element bonded to the sensor tube, the circuit element having an electrical characteristic that is dependent upon the deflection of the sensor tube, a sensing circuit electrically connected to the circuit element, the sensing circuit being configured to determine the fluid pressure within the sensor fluid conduit based on the electrical characteristic of the circuit element, and an output connector configured to output an electrical signal representative of the fluid pressure determined by the sensing circuit.

In some examples, the circuit element is bonded to a sensor tube sidewall of the sensor tube, or the circuit element is bonded to a diaphragm at the sensor tube end of the sensor tube. In some examples, the circuit element is bonded to the sensor tube sidewall of the sensor tube, the sensor tube sidewall comprising a thinner sensor tube sidewall proximate the sensor base and a thicker sensor tube sidewall proximate the sensor tube end, the circuit element being bonded to the thinner sensor tube sidewall, and the electrical characteristic of the circuit element being dependent upon the deflection of the thinner sensor tube sidewall. In some examples, the circuit element comprises a first circuit element having a first electrical characteristic dependent upon a first deflection of the thinner sensor tube sidewall, the pressure sensor further comprising a second circuit element bonded to the thicker sensor tube sidewall, the second circuit element having a second electrical characteristic that is dependent upon a second deflection of the thicker sensor tube sidewall, and the sensing circuit being configured to determine the fluid pressure within the sensor fluid conduit based on the first electrical characteristic of the first circuit element and the second electrical characteristic of the second circuit element.

In some examples, the circuit element comprises a strain gauge or is comprised of foil. In some examples, the sensor body comprises a single continuous machined piece of metal, or the sensor body comprises sensor body engagement features that are engaged with sensor cover engagement features of the sensor cover. In some examples, the system further comprises a hydraulic device comprising a device housing enclosing a fluid volume, the pressure sensor being in fluid communication with the fluid volume

In some examples, the output connector comprises an output connector body secured within an output connector cavity of the sensor cover by a fastener that extends through the sensor cover to the output connector cavity. In some examples, the pressure further comprises a potting material positioned within the sensor cover, the potting material comprising padding and/or insulation for the sensing circuit. In some examples, the pressure sensor further comprises a sensor adapter attached to the sensor body, the sensor adapter comprising an adapter fluid conduit that extends through the sensor adapter to the sensor fluid conduit, the adapter fluid conduit having an adapter fluid conduit radius that is less than a sensor fluid conduit radius of the sensor fluid conduit.

Also described herein are examples of methods to assemble pressure sensors. The pressure sensors may be designed to work with dynamic, high pressure, hydraulic systems. In some examples, the method includes attaching a sensor adapter to a sensor body. In some examples where an adapter is used, the adapter is both torqued/preloaded and welded (or otherwise attached) to the sensor body to reduce the chance of fluid leakage and/or further increase the durability of the pressure sensor. The sensor adapter can be welded to the sensor body, such as by a laser weld. The sensor body and the sensor adapter can additionally or alternatively be hardened by one or more techniques. The one or more gauges can be applied or secured to a portion of the sensor adapter, and/or a diaphragm attached to the sensor adapter. The gauges, the sensor body and/or the sensor adapter can be enclosed within a sensor cover, and then encased within a potting material to protect and/or insulate the components.

In some examples, the method includes attaching the one or more leads to an output connector; and/or securing the output connector to the sensor cover. In some examples, attaching the sensor adapter to the sensor body includes screwing the sensor adapter to the sensor body. In some examples, the sensor adapter and the sensor body are screwed at a torque between, for example, approximately 40 to 50 lb-ft.

In some examples, the welding includes laser welding. In examples, the welding includes autogenous laser welding. In some examples, the hardening includes heat treating the sensor adapter and the sensor body at a temperature ranging from, for example, approximately 800 to 1000 degrees Fahrenheit for between approximately 2 and 4 hours.

In some examples, the output connector is secured to the sensor cover with one or more set screws. In some examples, an input port adapter can be inserted into the sensor adapter to change a size of an input port of the pressure sensor. In some examples, the one or more gauges includes a strain gauge. In some examples, the potting employs a potting material comprising padding or insulation for the one or more gauges. In some examples, the method includes the further action of bonding the one or more gauges to a sensor tube sidewall of the sensor adapter, or the one or more gauges are bonded to a diaphragm at the sensor adapter.

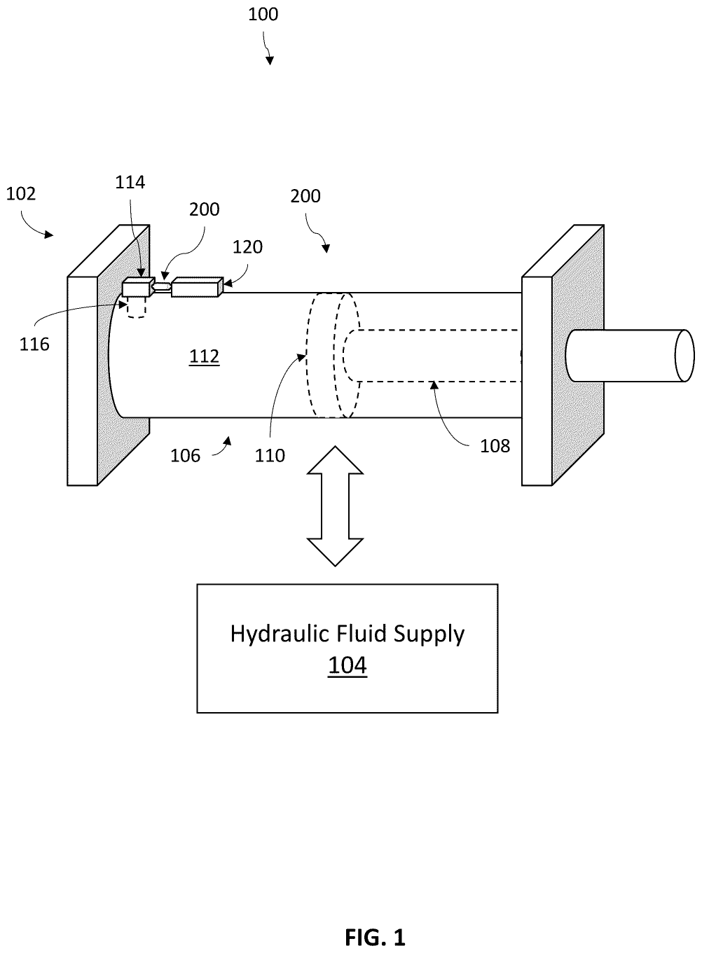

FIG. 1 shows an example of a hydraulic system 100. In the example of FIG. 1, the hydraulic system 100 includes a hydraulic actuator 102 and a hydraulic fluid supply 104 in fluid communication with the hydraulic actuator 102. In some examples, the hydraulic fluid supply 104 may include one or more hydraulic pumps and/or fluid tanks configured to circulate hydraulic fluid through the hydraulic actuator 102 of the hydraulic system 100.

In the example of FIG. 1, the hydraulic actuator 102 includes an actuator housing 106. Within the actuator housing 106 is positioned a hydraulic piston 108. A piston seal 110 of the hydraulic piston 108 is enclosed within the actuator housing 106 at the end of the hydraulic piston 108.

Hydraulic fluid pressures within an internal volume 112 of the actuator housing 106 may act upon the piston seal 110, and thereby move the hydraulic piston 108 (e.g., back and forth). Thus, accurate measurement of hydraulic fluid pressure within the internal volume 112 of the actuator housing 106 may be important for correct operation and/or control of the hydraulic system 100.

In the example of FIG. 1, the hydraulic system 100 includes a pressure sensor 200 to measure pressure within the internal volume 112 of the actuator housing 106. While only one pressure sensor 200 is shown in the example of FIG. 1, in some examples, two or more pressure sensors 200 may be used (e.g., to measure hydraulic pressure in two or more sections of the internal volume 112 of the actuator housing 106).

In the example of FIG. 1, the pressure sensor 200 is in fluid communication with the internal volume 112 of the actuator housing 106 via a manifold 114. As shown, the manifold 114 is in fluid communication with the internal volume 112 of the actuator housing 106 through a fluid port 116 that extends into the internal volume 112 of the actuator housing 106. As the manifold 114 is in fluid communication with the internal volume 112 of the actuator housing 106 through the fluid port 116, and the pressure sensor 200 is in fluid communication with the manifold 114, the pressure sensor 200 is in fluid communication with the internal volume 112 of the actuator housing 106.

In the example of FIG. 1, the pressure sensor 200 is also connected to, and/or in electrical communication with, an actuator controller 120 of the hydraulic actuator 102. In some examples, the pressure sensor 200 outputs one or more electric signals representative of the pressure within the inner volume 112 of the hydraulic actuator 102 to the actuator controller 120. In some examples, the actuator controller 120 may use the signal(s) from the pressure sensor 200 (and/or other pressure sensors) to control the hydraulic actuator 102 (and/or other portions of the hydraulic system 100).

While shown as including a hydraulic actuator 102 in the example of FIG. 1, in some examples, the hydraulic system 100 may include one or more additional, and/or alternative, hydraulic devices. In some examples, the hydraulic system 100 may be part of a larger system that tests various structures and/or machines (e.g., buildings, bridges, airplanes, trains, automobiles, ships, turbines, oil rigs, etc.). For example, the hydraulic system 100 may be used to test the reliability, durability, flexibility, balance, strength, and/or other aspects of the various structures and/or machines. In doing so, the hydraulic actuator 102, and/or the pressure sensor 200, may be subjected to dynamic hydraulic pressures up to 5000 pounds per square inch (psi), with possible pressure spikes of up to 15,000 psi.

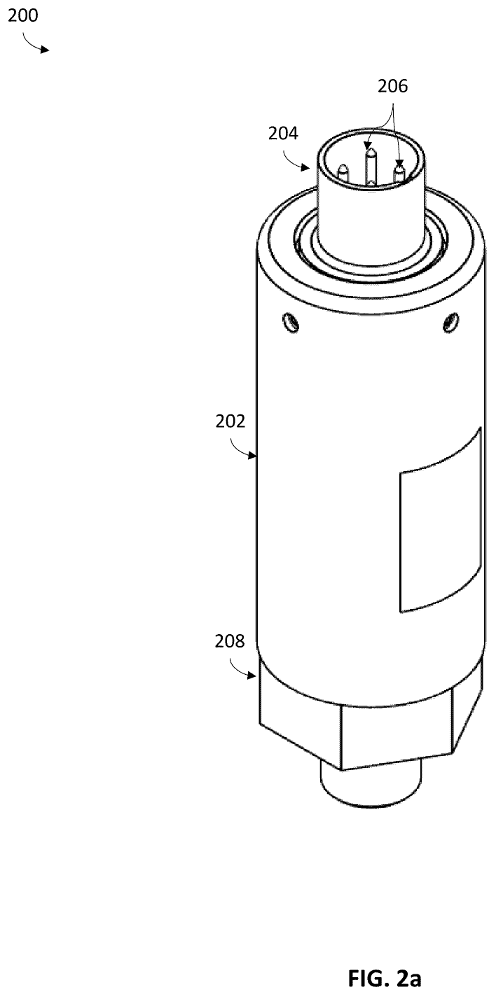

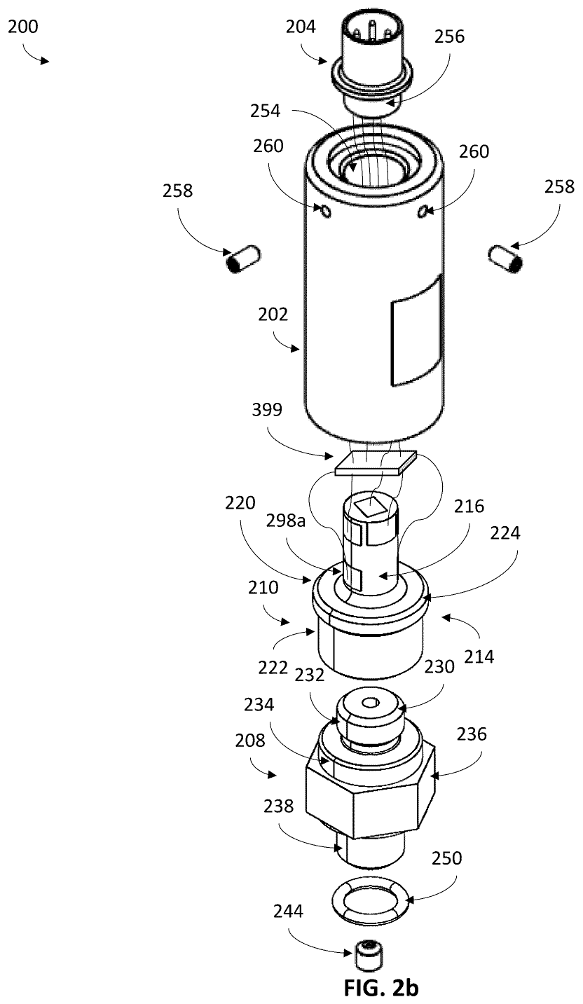

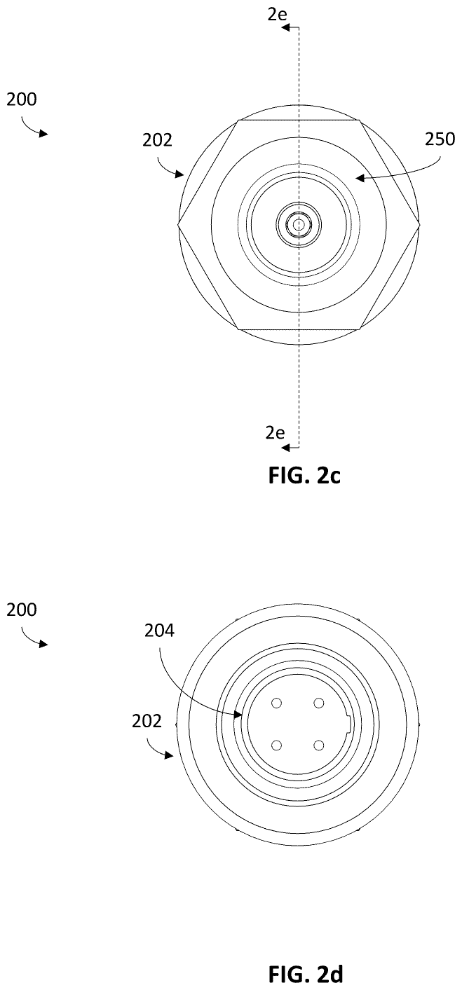

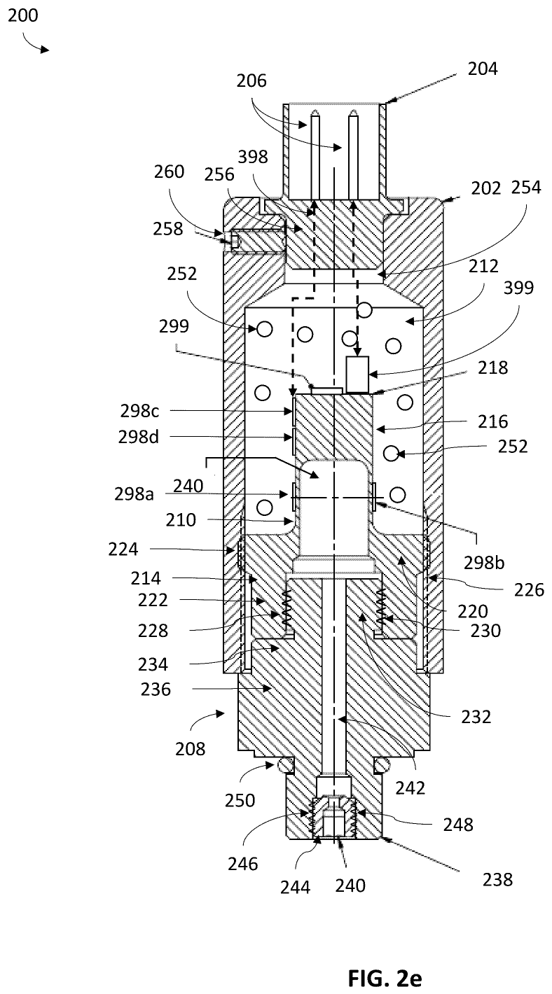

FIGS. 2a-2e show various enlarged views of the example pressure sensor 200. FIG. 2a shows a perspective view of the example pressure sensor 200. FIG. 2b shows an exploded view of the example pressure sensor 200. FIGS. 2c-2d show top and bottom views of the example pressure sensor 200. FIG. 2e shows a cross-section of the example pressure sensor 200.

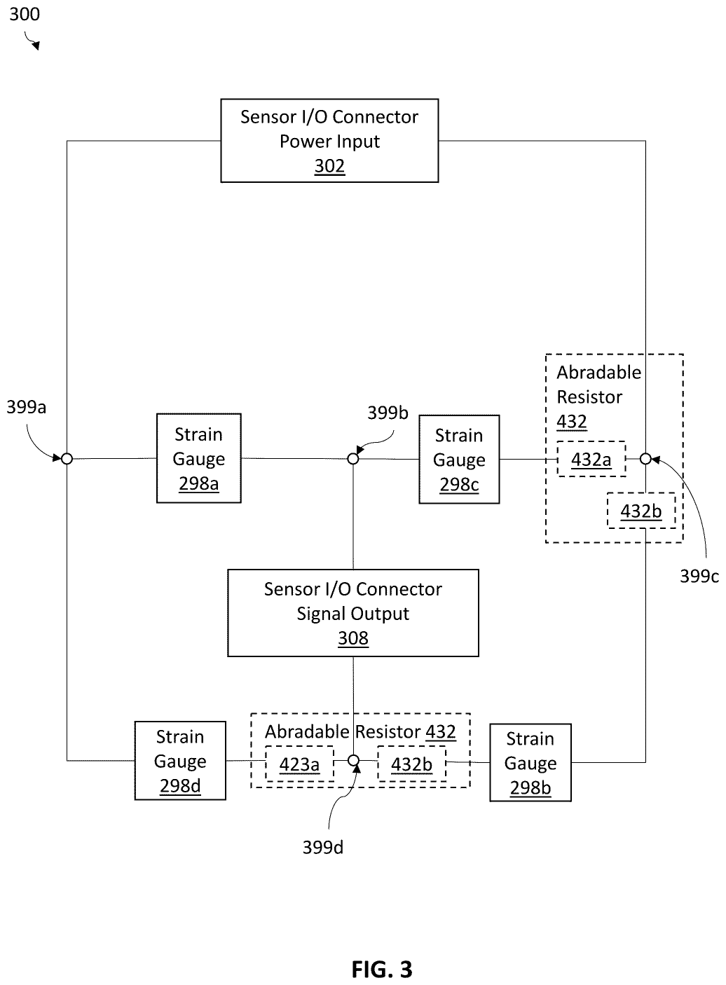

In the example of FIG. 2a, the pressure sensor 200 is shown as including a cylindrical sensor cover 202 attached to a sensor I/O connector 204. As shown, the sensor I/O connector 204 includes several electrically conductive pins 206, through which the sensor I/O connector 204 may be electrically connected to other devices (e.g., the actuator controller 120). In some examples, the pressure sensor 200 outputs a signal representative of a measured pressure via the (e.g., pins 206 of the) sensor I/O connector 204. In some examples, the pressure sensor 200 receives electrical power via the (e.g., pins 206 of the) sensor I/O connector 204, such as might be used to power a sensing circuit 300 (see, e.g., FIG. 3).

In the example of FIG. 2a, the pressure sensor 200 is further shown as including a sensor adapter 208 attached to the sensor cover 202. In some examples, the sensor adapter 208 is used to retrofit, configure, and/or adapt the pressure sensor 200 for use with an existing hydraulic system 100. For example, the pressure sensor 200 may be used as a replacement for an existing pressure sensor of a different design, and the sensor adapter 208 may configure the pressure sensor 200 to have a similar profile as the differently designed pressure sensor (e.g., so that the pressure sensor 200 can connect to the manifold 114 in the same way as the differently designed pressure sensor).

In the examples of FIGS. 2b and 2e, the pressure sensor 200 is further shown as including a sensor body 210. In the example of FIG. 2e, the sensor body 210 is shown as being encircled by, and/or enclosed within an internal sensor cavity 212 of, the sensor cover 202 when the pressure sensor 200 is assembled. The sensor body 210 is further shown coupled to the sensor cover 202 and the sensor adapter 208, when the pressure sensor 200 is assembled.

In the examples of FIGS. 2b and 2e, the sensor body 210 includes a sensor base 214 and a sensor tube 216 extending away from the sensor base 214. As shown, the sensor tube 216 extends approximately perpendicularly away from the sensor base 214 to a sensor tube end 218.

As shown, the sensor base 214 includes a first sensor base portion 220 that is closer to the sensor tube 216 and a second sensor base portion 222 that is farther from the sensor tube 216. Both the first sensor base portion 220 and second sensor base portion 222 are shown as being generally cylindrical. As shown, the first sensor base portion 220 has a larger diameter than the second sensor base portion 222.

In the examples of FIGS. 2b and 2e, the first sensor base portion 220 has first sensor base engagement features 224 (e.g., screw threads, grooves, protrusions, etc.) formed on its outer surface. In the example of FIG. 2e, the first sensor base engagement features 224 are shown engaged with complementary sensor cover engagement features 226 (e.g., screw threads, rails, grooves, protrusions, etc.) formed on an inner surface of the sensor cover 202. In some examples, the engagement of the first sensor base engagement features 224 with the sensor cover engagement features 226 serves to securely connect the sensor body 210 with the sensor cover 202.

In some examples, the first sensor base engagement features 224 and/or sensor cover engagement features 226 are treated with an anaerobic sealant and/or adhesive. In some examples, the sealant and/or adhesive is applied prior to connection of the sensor body 210 to the sensor cover 202. In some examples, the sealant and/or adhesive resists and/or prevents moisture and/or (e.g., hydraulic) fluid from moving past the point where the first sensor base engagement features 224 are engaged with the sensor cover engagement features 226, and/or into the internal sensor cavity 212 of the pressure sensor 200.

In the examples of FIG. 2e, the second sensor base portion 222 has second sensor base engagement features 228 (e.g., screw threads, grooves, protrusions, etc.) formed on its inner surface. As shown, the second sensor base engagement features 228 engage with complementary sensor adapter engagement features 230 on the outer surface of the sensor adapter 208. In some examples, the engagement of the second sensor base engagement features 228 with the sensor adapter engagement features 230 serves to securely connect the sensor body 210 to the sensor adapter 208.

In the examples of FIGS. 2b and 2e, the sensor adapter 208 includes a first adapter portion 232, a second adapter portion 234, a third adapter portion 236, and a fourth adapter portion 238. The first adapter portion 232 and fourth adapter portion 238 are shown at opposite ends of the sensor adapter 208. The first adapter portion 232 and fourth adapter portion 238 are also shown as being approximately cylindrical, with approximately the same radius/diameter.

In the example of FIG. 2e, the first adapter portion 232 of the sensor adapter 208 is positioned within an approximately cylindrical sensor fluid conduit 240 of the sensor body 210. As shown, the first adapter portion 232 is encircled by the second sensor base portion 222. As mentioned above, the first adapter portion 232 includes sensor adapter engagement features 230 on its outer surface that facilitate preloading engagement with the sensor body 210 via engagement with the second sensor base engagement features 228.

In the examples of FIGS. 2b and 2e, the first adapter portion 232 is connected to and/or continuous with a second adapter portion 234. As shown, the second adapter portion 234 is approximately cylindrical with a radius/diameter that is larger than that of the first adapter portion 232 and/or approximately equal to that of the second sensor base portion 222.

In the example of FIG. 2e, the second adapter portion 234 is shown abutting an end of the second sensor base portion 222. In some examples, the sensor adapter 208 is further secured to the sensor body 210 at the intersection/abutment of the second adapter portion 234 and second sensor base portion via an annular weld (e.g., laser welding) and/or some other fastening means (e.g., adhesive). In some examples, the connection of the sensor adapter 208 to the sensor body 210 via both engagement features and welding (and/or other fastening means) helps to ensure the sensor body 210 and sensor adapter 208 can withstand the fatigue/stresses of high pressure hydraulic systems while still remaining connected and/or resisting/preventing fluid leakage.

While, in some examples, the sensor body 210 and adapter 208 might instead be machined as one piece (rather than being connected together) this might be a more difficult and/or expensive machining process, and/or may introduce weaknesses into the structure. In contrast, the pressure sensor 200 design shown in FIGS. 2a-2e is relatively cheap and easy to manufacture.

In the examples of FIGS. 2b and 2e, the second adapter portion 234 is connected to and/or continuous with a third adapter portion 236. As shown, the third adapter portion 236 is a hexagonal prism. In some examples, the hexagonal shape of the third adapter portion 236 facilitates gripping by a tool (e.g., wrench, socket wrench, etc.), which can be useful when torquing, twisting, and/or turning the sensor adapter 208 (e.g., to secure together the engagement features and/or preload the joint between the sensor body 210 and sensor adapter 208).

In the examples of FIGS. 2b and 2e, the third adapter portion 236 has a radius/diameter that is larger than that of the first adapter portion 232 and second adapter portion 234. The radius/diameter of the third adapter portion 236 is shown as being approximately equal to, or slightly larger than, the radius/diameter of the first sensor base portion 220 and/or an inner radius/diameter of the sensor cover 202, which allows the third adapter portion 236 to abut the sensor cover 202. In some examples, the abutment of the third adapter portion 236 and cover 202 prevents the sensor adapter 208 (and/or attached sensor body 210) from moving further into the sensor cover 202.

In the examples of FIGS. 2b and 2e, the third adapter portion 236 is connected to a fourth adapter portion 238. As shown, the fourth adapter portion is generally cylindrical, with a radius/diameter that is approximately equal to the first adapter portion 232.

In the example of FIG. 2e, the fourth adapter portion 238 includes an approximately cylindrical adapter input port 240 that leads to an approximately cylindrical adapter fluid conduit 242. As shown, the adapter fluid conduit 242 is in fluid communication with the sensor fluid conduit 240. The adapter fluid conduit 242 is further shown with a substantially smaller radius/diameter than the sensor fluid conduit 240.

In the example of FIG. 2e, an additional insert 244 (e.g., set screw) is shown inserted within the adapter input port 240. As shown, the insert 244 includes insert engagement features 246 (e.g., screw threads) that engage complementary adapter input port engagement features 248 formed on the inner surface of the sensor adapter 208 encircling the adapter input port 240. In some examples, the insert 244 may instead be friction fit within the adapter input port 240.

In some examples, the insert 244 is used to further decrease the radius/diameter of the adapter input port 240. In some examples, making the radius/diameter of the adapter input port 240 smaller can help to reduce stress/fatigue that might be introduced by spikes in fluid pressure. In some examples, the insert engagement features 246 may also allow for the insert 244 to be removable, such that different inserts can be used to resize the adapter input port 240 for different hydraulic applications/systems.

In some examples, using inserts 244 of different diameters and/or lengths may result in different Helmholz resonance characteristics (e.g., making a resonant frequency higher or lower). As used herein, Helmholz resonance refers to the inward and/or outward flow of air (and/or the unique sound the air makes when flowing inward and/or outward). In some examples, using inserts 244 with particular diameters and/or lengths may also help to attenuate high frequency and/or high magnitude pressure spikes that may damage and/or induce failure in the strain gauges 298 and/or the structure of the pressure sensor 200.

In the examples of FIGS. 2a and 2e, the pressure sensor 200 further includes a sealing ring 250 fit around a cylindrical groove between the third adapter portion 236 and the fourth adapter portion 238. In some examples where the pressure sensor 200 is used with the hydraulic system 100, the fourth adapter portion 238 may be received within a manifold port of the manifold 114, and the sealing ring 250 may be used to seal the connection between the sensor adapter 208 and manifold 114. In some examples, the sealing ring 250 may be a rubber O-ring or metal (e.g., copper, aluminum, etc.) sealing washer.

In some examples, when connected with the hydraulic system 100 (and/or other hydraulic system), the adapter input port 240 and/or adapter fluid conduit 242 may be put in fluid communication with hydraulic fluid (e.g., hydraulic fluid flowing within the interior volume 112 of the hydraulic actuator 102, fluid port 116, and/or manifold 114). In some examples, hydraulic fluid will enter the adapter input port 240 and flow through the adapter fluid conduit 242 into the sensor fluid conduit 240.

As shown in FIG. 2e, the sensor fluid conduit 240 extends through the sensor base 214 and into a sensor tube 216 of the sensor body 210. In some examples, fluid pressure from fluid in the sensor fluid conduit 240 may cause the sensor body 210 (and/or sensor tube 216) to deflect, deform, distend, and/or otherwise react to the stress of fluid pressure.

In the examples of FIGS. 2b and 2e, the sensor tube 216 is approximately cylindrical. In some examples, the cylindrical shape of the sensor tube 216 makes the sensor tube 216 more durable than if it had a polygonal shape, due to the reduced number of edges and/or corners, which may rupture under pressure. Additionally, a cylindrical shape may be less difficult and/or expensive to machine than polygonal shapes (and/or square holes).

In some examples, the sensor body 210 (including the sensor base 214 and sensor tube 216) comprises one solid and/or continuous machined piece of (e.g., steel and/or other metal) material, with no welded connections. In some examples, this one piece design may help the sensor body 210 to better withstand the high pressures and/or stresses of the hydraulic system 100, as opposed to welded designs which might be more susceptible to failure along weld seems under high pressures and/or stresses.

In the examples of FIGS. 2b and 2e, the sensor body 210 further includes several strain gauges 298 coupled to an outside surface of the sensor tube 216. In some examples, each strain gauge 298 comprises an electrical and/or circuit element whose electrical resistance (and/or impedance) varies with applied force. For example, the resistance of a strain gauge 298 may increase as the strain gauge 298 is stretched. As each strain gauge 298 bonded to sensor tube 216, each strain gauge 298 will stretch as the sensor tube 216 stretches (and/or deflects, deforms, distends, etc.), such as may occur in response to fluid pressure from fluid within the sensor fluid conduit 240. In some examples, fluid pressure from fluid within the sensor fluid conduit 240 imparts hoop stress upon the sensor body 210 (i.e., sensor base 214 and/or sensor tube 216), and the strain gauges 298 respond to the hoop stress placed on the sensor tube 216.

In some examples, fluid pressure within the senor fluid conduit 240 imparts bending and/or bulging stress upon the entire sensor body 210 due to the high pressures of the hydraulic fluid (and/or the attachment of the pressure sensor 200 to the manifold 114). In some examples, much of this bending and/or bulging stress may be experienced by the sensor base 214 of the sensor body 210.

In some examples, placing the strain gauges 298 on a sensor tube 216 that extends away from the sensor base 214 of the sensor body 210 may isolate the strain gauges 298 from most of the outward bulging effects that may be experienced by the sensor base 214. This can be important, as such bulging effects might otherwise impact the strain gauges 298 (e.g., the resistance of the strain gauges) in such a way that distorts the measurements and/or outputs of the sensor 200.

In some examples, each strain gauge 298 is comprised of a foil material. In some examples, foil strain gauges 298 are used in the pressure sensor 200 because foil strain gauges 298 are more resilient and/or able to withstand higher stresses. This is in contrast to, for example, piezoelectric elements that are more fragile and therefore more susceptible to breakage under the high temperatures and/or stresses of the hydraulic system 100. The strain gauges 298 are further bonded to an outer surface of the sensor tube 216 so that the strain gauges 298 are protected from direct contact with the hot, pressurized, hydraulic fluid flowing through the interior of the sensor tube 216.

The bonding of the strain gauges 298 to the outer surface of the sensor tube 216 is also advantageous because it allows for mechanical modification of the sensor tube 216 (and/or sensor base 214) even after the strain gauges 298 have been bonded to the sensor tube 216. For example, this configuration means that a mechanical tool may be inserted into the sensor fluid conduit 240 (e.g., from the adapter input port 240 and/or an opening in the sensor base 214) to mechanically modify the sensor base 214 and/or sensor tube 216 from within. For example, a mechanical tool may mechanically modify a width of a sidewall of the sensor tube 216 (e.g., to make the sidewall thinner).

In the example of FIG. 2e, strain gauge 298c and strain gauge 298d are shown as being bonded to a sidewall of the sensor tube 216 at a position farther from the sensor base 214, and closer to the sensor tube end 218 of the sensor tube 216. Strain gauge 298a and strain gauge 298b are shown as being bonded to a sidewall of the sensor tube 216 that is closer to the sensor base 214 and farther from the sensor tube end 218 of the sensor tube 216. Strain gauge 298a and strain gauge 298b are further shown bonded to opposite sides of the sensor tube 216.

In the example of FIG. 2e, the fluid conduit extends within the sensor tube 216 proximate the placement of, and/or between, the strain gauge 298a and strain gauge 298b. Where the sensor fluid conduit 240 extends through the sensor tube 216, the sidewall width of the sensor tube 216 is relatively small/thin.

However, as shown in the example of FIG. 2e, the sensor fluid conduit 240 stops approximately halfway through the sensor tube 216. This results in the sensor tube 216 being generally solid and/or continuous proximate the sensor tube end 218. At this generally solid and/or continuous portion of the sensor tube 216, the sidewall width of the sensor tube 216 is far greater/thicker.

In the example of FIG. 2e, the strain gauge 298a and strain gauge 298b are bonded to the thinner sidewall portion of the sensor tube 216. In some examples, the thinner sidewall portion of the sensor tube 216 is likely to experience a significant and/or measurable deflection (e.g., due to fluid pressure within the sensor fluid conduit 240). In some examples, because the strain gauge 298a and/or strain gauge 298b are bonded to the thinner sidewall portion of the sensor tube 216, the strain gauge 298a and/or strain gauge 298b will experience a significant and/or measurable deflection similar to that of the thinner sidewall portion of the sensor tube 216.

In the example of FIG. 2e, the strain gauge 298c and strain gauge 298d are bonded to the thicker sidewall portion of the sensor tube 216. In some examples, the thicker sidewall portion of the sensor tube 216 is likely to experience negligible and/or insignificant deflection (e.g., as compared to the thinner sidewall portion of the sensor tube 216). In some examples, because the strain gauge 298c and strain gauge 298d are bonded to the thicker sidewall portion of the sensor tube 216, the strain gauge 298c and/or strain gauge 298d will experience negligible and/or insignificant deflection similar to that of the thicker sidewall portion of the sensor tube 216.

In the example of FIG. 2b, the strain gauges 298 are shown electrically connected to a sensing circuit terminals 399 that are, in turn, connected to the I/O pins 206 of the sensor I/O connector 204. While shown as separate in FIG. 2b, in some examples, the sensing circuit terminals 399 are formed as part of, or bonded to, (e.g., the sidewall and/or top end 218 of) the sensor tube 216 (see, e.g., FIG. 2e). In some examples, a sensing circuit 300 is formed via electrical connections between the strain gauges 298, sensing circuit terminals 399, and I/O pins 206 of the sensor I/O connector 204 (see, e.g., FIG. 3). In some examples, the strain gauges 298 and/or sensing circuit terminals 399 are electrically connected to the I/O pins 206 via one or more contacts or leads 398.

In some examples, the sensing circuit 300 is configured to detect and/or output an electrical signal representative of a difference between the resistances of the strain gauges 298a, 298b and the resistances of the strain gauges 298c, 298d. In some examples where there is no/negligible fluid pressure within the sensor fluid conduit 240, neither set of strain gauges 298 will experience any change in resistance due to deflection, and the output of the sensing circuit 300 will be representative of an approximately zero value.

In some examples where there is significant and/or measurable fluid pressure within the sensor fluid conduit 240, the strain gauges 298ab will experience a significant and/or measurable change in resistance due to deflection due to deflection of the thinner sidewall portion of the sensor tube 216. Meanwhile the strain gauges 298cd will experience a comparably negligible and/or insubstantial change in resistance due to deflection due to a comparably negligible and/or insubstantial deflection of the thicker sidewall portion of the sensor tube 216. Thus, in some examples where the sensing circuit 300 is configured to detect and/or output a difference between the resistances of the strain gauges 298a, 298b and the resistances of the strain gauges 298c, 298d, the output of the sensing circuit 300 will be representative of a non-zero value.

In the examples of FIGS. 2b and 2e, the pressure sensor 200 further includes an abradable resistor 299. In some examples, the resistance(s) of the abradable resistor 299 may be modified through abrasion. In some examples, the abradable resistor 299 may be used for balancing the sensing circuit 300 and/or for temperature compensation.

While shown as being attached to the sensor tube end 218 of the sensor tube 216 in the examples of FIGS. 2b and 2e, in some examples, the abradable resistor 299 may instead be positioned on a sidewall of the sensor tube 216 or on the sensor base 214. While the strain gauges 298cd are shown positioned on the thicker sidewall portion of the sensor tube 216, in some examples one or more of the strain gauges 298cd may instead be positioned at/on the sensor tube end 218.

FIG. 3 shows an example of a sensing circuit 300 that uses the strain gauges 298 and abradable resistor 299 to generate an output signal representative of a fluid pressure within the sensor fluid conduit 240 of the sensor body 210. In the example of FIG. 3, the sensing circuit 300 is a modified Wheatstone bridge, with the strain gauges 298 forming the primary resistive elements of the Wheatstone bridge. As shown, strain gauge 298a and strain gauge 298c are wired together in series, strain gauge 298b and strain gauge 298d are wired together in series, and those two series are wired in parallel to one another with respect to a power input 302 (and/or the power input pin(s) 206) of the sensor I/O connector 204. In some examples, the power input 302 (and/or the power input pin(s) 206) of the sensor I/O connector 204 may be connected to a power source of the hydraulic system 100 (e.g., via the actuator controller 120).

In the example of FIG. 3, terminal 399b and terminal 399d of the sensing circuit 300 are connected to an output 304 (and/or the output signal pins 206) of the sensor I/O connector 204. In some examples, when the voltage across terminal 399b and terminal 399d (and/or current flowing from terminal 399b to terminal 399d) is zero, the output 304 of the sensor I/O connector 204 will be zero.

In some examples, a zero output of the sensor I/O connector 204 may be the result of the strain gauge 298a and/or strain gauge 298b having a resistance approximately equal to the resistance of the strain gauge 298c and/or strain gauge 298d. In some examples, the strain gauge 298a and/or strain gauge 298b having a resistance approximately equal to the resistance of the strain gauge 298c and/or strain gauge 298d may occur when the deflection of the thinner sidewall portion of the sensor tube 216 is approximately equal to the deflection of the thicker sidewall portion of the sensor tube 216. In some examples, the deflection of the thinner sidewall portion of the sensor tube 216 is approximately equal to the deflection of the thicker sidewall portion of the sensor tube 216 when there is no fluid pressure within sensor fluid conduit 240 of the sensor tube 216.

In some examples, when the voltage across terminal 399b and terminal 399d (and/or current flowing from terminal 399b to terminal 399d) is non-zero, the output 304 of the sensor I/O connector 204 will be non-zero. In some examples, a non-zero output of the sensor I/O connector 204 may be the result of the strain gauge 298a and/or strain gauge 298b having a resistance that is measurable different than the resistance of the strain gauge 298c and/or strain gauge 298d. In some examples, the strain gauge 298a and/or strain gauge 298b having a resistance measurable different than the resistance of the strain gauge 298c and/or strain gauge 298d may occur when the deflection of the thinner sidewall portion of the sensor tube 216 is measurable different than the deflection of the thicker sidewall portion of the sensor tube 216. In some examples, the deflection of the thinner sidewall portion of the sensor tube 216 is measurable different than the deflection of the thicker sidewall portion of the sensor tube 216 when there is significant, substantial, non-trivial, and/or measurable fluid pressure within sensor fluid conduit 240 of the sensor tube 216.

In the example of FIG. 3, each abradable resistor 299 is depicted in dashed lines showing how they might be potentially placed in the sensing circuit 300 if needed. As shown, each abradable resistor 299 may be used in place of a terminal 399c/399d (and/or includes its own internal terminal). Each abradable resistor 299 essentially comprises two resistors 299a and 299b positioned on either sides of the terminal 399c/399d. In some examples, the resistance of each resistor 299a/299b of the abradable resistor 299 may be modified through abrasion. In some examples where multiple abradable resistors 299 are included, one of the abradable resistors 299 (e.g., replacing terminal 399c) may be used for balancing the Wheatstone bridge, while the other abradable resistor 299 (e.g., replacing terminal 399d) may be used for temperature compensation. While shown as replacing terminals 399c and 399d, in some examples, the abradable resistors may instead replace terminals 399a and/or 399b.

While the sensing circuit 300 of FIG. 3 is shown as a bridge including four strain gauges 298, in some examples, the sensing circuit 300 may contain more strain gauges 298 and/or bridges. However, such a configuration may be more complicated and/or require more power. In some examples, the sensing circuit 300 may include fewer strain gauges 298 and/or a half bridge, though such a configuration might be less effective.

Though the sensing circuit 300 of FIG. 3 is shown in a particular configuration, in some examples, the sensing circuit 300 may be differently configured. For example, the sensing circuit 300 may use different sensing elements (e.g., instead of, and/or in addition to, the strain gauges 298). For example, one or more of the strain gauges 298 may be replaced by sensors that detect and/or measure the deflection of sensor tube 216 using different means (e.g., optical, ultrasonic, etc.).

While the sensing circuit 300 of FIG. 3 is shown as an analog circuit, in some examples, the sensing circuit 300 may be digital and/or include one or more digital elements (e.g., analog to digital converter(s)). In some examples, one or more of the strain gauges 298 may be connected to a processing chip, such as a digital signal processor, and the processing chip may implement one or more functions of the sensing circuit 300. In some examples, one or more amplifiers may be included in the sensing circuit 300 to amplify the output of the sensing circuit 300.

In the example of FIG. 2e, the sensing circuit terminals 399, strain gauges 298, abradable resistor 299, and sensor tube 216 are shown encircled by the sensor cover 202, and/or enclosed within a sensor cavity 212 defined by the sensor cover 202, sensor base 214 and sensor I/O connector 204. As shown, a potting material 252 is also inside the sensor cover 202 and/or the sensor cavity 212.

In some examples, the potting material 252 is a low viscosity elastomer. In some examples, the potting material serves as padding and/or insulation for the sensing circuit 300 and/or the one or more leads 398 connecting the strain gauges 298, abradable resistor 299, sensing circuit 300, and/or sensor I/O connector 204. In some examples, the potting material 252 may be inserted into the sensor cavity 212 before the sensor body 210 is connected to the sensor cover 202. In some examples, the potting material may be inserted into the sensor cover 202 and/or sensor cavity 212 through an I/O connector cavity 254 of the sensor cover 202.

In the example of FIG. 2b, the sensor I/O connector 204 is positioned for insertion into the I/O connector cavity 254 of the sensor cover 202. FIG. 2e shows an I/O connector base 256 of the sensor I/O connector 204 positioned within the I/O connector cavity 254. As shown, two connector fasteners 258 extend through two fastener channels 260 in the sensor cover 202 and into the I/O connector cavity 254 to press against the I/O connector base 256 and secure the I/O connector base 256 in the I/O connector cavity 254.

In some examples, the use of the connector fasteners 258 to secure the sensor I/O connector 204 has several advantages over alternative ways in which to secure the output connector. For example, when using connector fasteners 258, there is no need to turn or twist the sensor I/O connector 204 to secure the sensor I/O connector 204 (e.g., as might be required with screw threads), which means any wires connected to the sensor I/O connector 204 will similarly avoid being twisted (which might damage the wires). As another example, using the connector fasteners 258 will avoid welding the sensor I/O connector 204 to the sensor cover 202, which might ignite and/or otherwise damage the potting material. As another example, when using the connector fasteners 258 the sensor I/O connector 204 may be removed from the sensor cover 202 by removing the connector fasteners 258, after which the components in the sensor cavity 212 may be accessed through the I/O connector cavity 254 (which may be useful for repairs, diagnostics, etc.). In some examples, welding can be employed, such as a low power laser weld selected to create a suitable bond between components without causing excess heat within (e.g., without heating the components or potting material inside the sensor assembly).

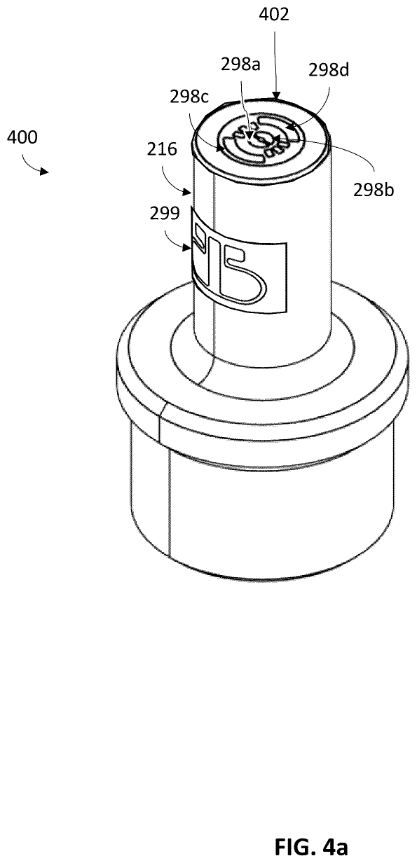

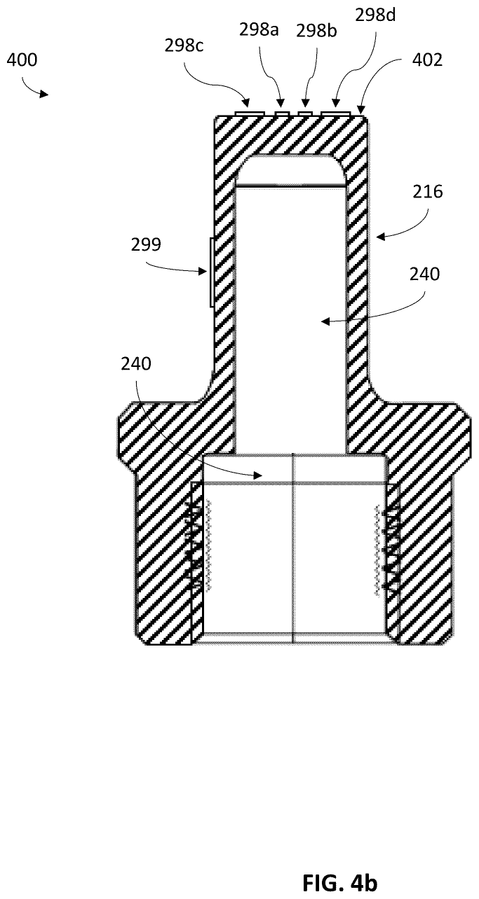

FIGS. 4a-4b show an example alternative sensor body 400 that might be used in the pressure sensor 200. As shown, the alternative sensor body 400 of FIGS. 4a-4b is similar (and/or identical) to the sensor body 210 of FIGS. 2b and 2e, except that the alternative sensor body 400 has strain gauges 298 bonded to a diaphragm 402 at the end of the sensor tube 216, while an abradable sensor 299 is bonded to the sidewall of the sensor tube 216.

Because the strain gauges 298 are bonded to the diaphragm 402 instead of the sidewalls of the sensor tube 216, there is no need for a thicker sidewall portion and/or thinner sidewall portion of the sensor tube 216. Thus, in the example of FIG. 4b, the sidewall thickness of the sensor tube 216 is shown as being approximately uniform throughout.

In the examples of FIG. 4b, the sensor diaphragm 402 closes off the end of the sensor tube 216 (and/or sensor fluid conduit 240). As shown, the sensor diaphragm 402 is approximately circular. The sensor diaphragm 402 is further shown as having a width that is about as thick as the width of the sidewall of the sensor tube 216.

In some examples, the relatively thin width of the diaphragm 402 allows for the fluid pressure of the hydraulic fluid in the sensor fluid conduit 240 to force (e.g., a middle portion of) the diaphragm 402 to deflect, distend, deform, and/or bend outwards. In some examples, the outer portions of the diaphragm 402 may deflect, distend, deform, and/or bend far less than the middle portions.

In the examples of FIGS. 4a-4b, the alternative sensor body 400 includes strain gauges 298 attached, fastened, adhered, and/or otherwise bonded to the diaphragm 402. As shown in FIGS. 4a-4b, four strain gauges 298 are shown bonded to the diaphragm 402. Each strain gauge 298 is shown bonded to an outer face of a diaphragm 402 that is outside of the sensor fluid conduit 240 and/or sensor tube 216, as well as opposite an inner face of the diaphragm 402 positioned within the sensor fluid conduit 240 and/or sensor tube 216. In some examples, when so positioned on the diaphragm 402, the inner/middle strain gauge 298a and/or strain gauge 298b may respond to and/or measure circumferential and/or hoop strain, while the outer strain gauge 298c and/or strain gauge 298d may respond to and/or measure radial strain. In some examples, the pressure sensor 200 may primarily use the strain gauge 298a and/or strain gauge 298b bonded to the middle portion of the diaphragm 402 for pressure detection, while the strain gauge 298c and/or strain gauge 298d bonded to the outer portion of the diaphragm 402 are used as “dead” gauges.

In some examples, the sensor body 210 and diaphragm 402 may comprise one solid and/or continuous machined piece of (e.g., steel and/or other metal) material, with no welded connections. In some examples, this one piece design may help the pressure sensor 200 to better withstand the high pressures and/or stresses of the hydraulic system 100, as opposed to welded designs which might be more susceptible to failure along weld seems under high pressures and/or stresses.

In some examples, placing the diaphragm 402 and/or strain gauges 298 at the end of sensor tube 216 may isolate the diaphragm 402 and/or strain gauges 298 from most of the outward bulging effects that may be experienced by the sensor body 210 (e.g., in response to fluid pressures). This can be important, as such bulging of the sensor tube 216 near the diaphragm 402 may impact the (e.g., resistance of the) strain gauges 298 in such a way that distorts the measurements and/or outputs of the pressure sensor 200.

The pressure sensor 200 disclosed herein has a unique design that makes it especially suited for dynamic, high pressure, hydraulic systems 100. For example, the one piece design of its sensor body 210 increases the durability of the pressure sensor 200. In some examples where an adapter 208 is used, the adapter 208 is both torqued/preloaded and welded (or otherwise attached) to the sensor body 210 to reduce the chance of fluid leakage and/or further increase the durability of the pressure sensor 200. Additionally, the use of foil (rather than, for example, piezoelectric) strain gauges 298 ensures continued functionality even under the unique stresses imposed by dynamic, high pressure, hydraulic systems 100. Furthermore, the sensor tube 216 helps to isolate the diaphragm 402 and/or strain gauges 298 from some of the bowing/bending stresses that the sensor base 214 of the sensor body 210 may experience due to the intense fluid pressures.

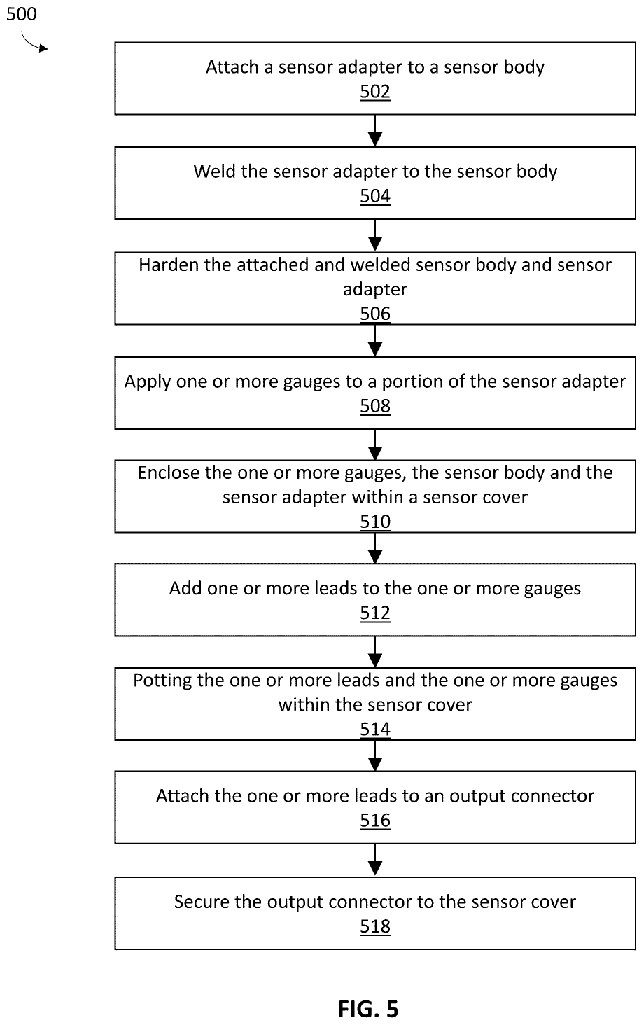

Turning to FIG. 5, an example method 500 is provided for assembling a pressure sensor. For instance, the method can be used to assemble the pressure sensors described with respect to FIGS. 2a-2e (e.g., pressure sensor 200) and the alternative example sensor body shown in FIGS. 4a-4b (e.g., a pressure sensor employing alternative sensor body 400), however the method is not limited to these pressure sensors.

As shown in block 502 of FIG. 5, a sensor adapter (e.g., sensor adapter 208) is attached to a sensor body (e.g., sensor adapter 208). For example, attaching the sensor adapter to the sensor body can be accomplished in a number of ways, including screwing the sensor adapter to the sensor body. In this example, the torque by which the sensor adapter and the sensor body are screwed can range between a minimum or lower threshold value (e.g., approximately 40 lb-ft) to a maximum or upper threshold value (e.g., approximately 50 lb-ft).

Although some examples are described as using internal and external threads to attach the sensor adapter to the sensor body, respectively, other devices, methods and/or techniques can be used to attach the sensor adapter to the sensor body. For instance, the two components can be press-fit, clamped, or otherwise joined, provided the bond between the components is sufficient to withstand the high-pressure environment in which the assembly operates.

In block 504, the sensor adapter is welded to the sensor body. In particular, having been attached with the desired tolerance, an interface between the components can be welded. Example techniques include laser welding and/or autogenous laser welding, as a list of non-limiting examples.

Once the components are attached and welded, the sensor body and the sensor adapter are hardened, as shown in block 506. For instance, hardening of the components can include heat treating the sensor adapter and the sensor body at a predetermined temperature (or range of temperatures) for a given amount of time. The temperature(s) can range from between a minimum threshold temperature value (e.g., approximately 800 degrees Fahrenheit) to a maximum threshold temperature value (e.g., approximately 1000 degrees Fahrenheit for a given amount of time (e.g., between 2 and 4 hours).

Although some examples describe the components as being attached and/or welded prior to hardening, in other examples hardening can be performed before the components are attached and/or welded.

In block 508, one or more gauges are applied to a portion of the sensor adapter. For example, the gauge(s) can include a strain gauge (e.g., strain gauges 298), but can be other types of gauges or sensors suitable for measuring changes in pressure and/or force. In some additional or alternative methods, the one or more gauges can be bonded to a sidewall of a sensor tube of the sensor adapter. In some examples, the sensor adapter includes a diaphragm (e.g., diaphragm 402), onto which the one or more gauges are bonded.

In block 510, the one or more gauges, the sensor body and the sensor adapter are enclosed within a sensor cover. In some examples, the sensor cover (e.g., sensor cover 202) has a cylindrical shape with one or more openings, which can be slid over the sensor body and the sensor adapter.

In block 512, one or more leads are added to the one or more gauges. The leads (e.g., contacts or leads 398) can connect to the gauges themselves, and/or internal circuitry associated with the gauges (e.g., sensing circuit 300, sensing circuit terminals 399). The leads 398 may be flexible (e.g., a wire) and have a length sufficient to extend from the sensor cover (e.g., for connection with leads 206 of adapter 204).

In block 514, the one or more leads and the one or more gauges are potted within the sensor cover. As disclosed herein, a potting material (e.g., potting material 252) can be injected into the sensor cover (e.g., before and/or after the sensor body is connected to the sensor cover). The potting material serves to physically and/or electrically insulate components within the sensor cover, such as the sensing circuit 300, leads 398, gauges 298, abradable resistor 299, sensing circuit 300, and/or sensor I/O connector 204.

As the one or more leads are arranged to extend from the sensor cover as potting is being applied, the leads are available to be attached to an output connector (e.g., connector 204), in block 516.

In block 518, the output connector is secured to the sensor cover. In some examples, the output connector is secured to the sensor cover with one or more set screws, although other types of fasteners and/or joining techniques are considered within the scope of this disclosure. As a result,

In some additional or alternative methods, the assembly includes an input port to receive a fluid. The input port can have an adjustable size, and can be configured to receive an input port adapter into the input port. For instance, a sensor adapter can encircle the adapter input port to change a size of the input port of the pressure sensor.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z”means “one or more of x, y and z”.

As utilized herein, the terms “e.g.,” and “for example” set off lists of one or more non-limiting examples, instances, or illustrations.

As used herein, “approximately” means within a 5% margin of error, unless otherwise specified.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

1. A hydraulic system, comprising:
a pressure sensor in fluid communication with the fluid volume, the pressure sensor comprising:
a sensor cover;
a sensor body positioned within the sensor cover, the sensor body comprising:
a sensor base, 'a sensor tube connected to the sensor base and extending away from the sensor base to a sensor tube end, and
a sensor fluid conduit extending through the sensor base and into the sensor tube, the sensor fluid conduit being in fluid communication with the fluid volume, and the sensor tube being configured to experience a deflection in response to a fluid pressure within the sensor fluid conduit,
a circuit element bonded to the sensor tube, the circuit element having an electrical characteristic that is dependent upon the deflection of the sensor tube,
a sensing circuit electrically connected to the circuit element, the sensing circuit being configured to determine the fluid pressure within the sensor fluid conduit based on the electrical characteristic of the circuit element, and
an output connector configured to output an electrical signal representative of the fluid pressure determined by the sensing circuit.

2. The system of claim 1, wherein the circuit element is bonded to a sensor tube sidewall of the sensor tube, or the circuit element is bonded to a diaphragm at the sensor tube end of the sensor tube.

3. The system of claim 2, wherein the circuit element is bonded to the sensor tube sidewall of the sensor tube, the sensor tube sidewall comprising a thinner sensor tube sidewall proximate the sensor base and a thicker sensor tube sidewall proximate the sensor tube end, the circuit element being bonded to the thinner sensor tube sidewall, and the electrical characteristic of the circuit element being dependent upon the deflection of the thinner sensor tube sidewall.

4. The system of claim 3, wherein the circuit element comprises a first circuit element having a first electrical characteristic dependent upon a first deflection of the thinner sensor tube sidewall, the pressure sensor further comprising a second circuit element bonded to the thicker sensor tube sidewall, the second circuit element having a second electrical characteristic that is dependent upon a second deflection of the thicker sensor tube sidewall, and the sensing circuit being configured to determine the fluid pressure within the sensor fluid conduit based on the first electrical characteristic of the first circuit element and the second electrical characteristic of the second circuit element.

5. The system of claim 1, wherein the circuit element comprises a strain gauge or is comprised of foil.

6. The system of claim 1, wherein the sensor body comprises a single continuous machined piece of metal, or the sensor body comprises sensor body engagement features that are engaged with sensor cover engagement features of the sensor cover.

7. The system of claim 1, further comprising a hydraulic device comprising a device housing enclosing a fluid volume, the pressure sensor being in fluid communication with the fluid volume

8. The system of claim 1, wherein the output connector comprises an output connector body secured within an output connector cavity of the sensor cover by a fastener that extends through the sensor cover to the output connector cavity.

9. The system of claim 1, further comprising a potting material positioned within the sensor cover, the potting material comprising padding and/or insulation for the sensing circuit.

10. The system of claim 1, further comprising a sensor adapter attached to the sensor body, the sensor adapter comprising an adapter fluid conduit that extends through the sensor adapter to the sensor fluid conduit, the adapter fluid conduit having an adapter fluid conduit radius that is less than a sensor fluid conduit radius of the sensor fluid conduit.

11. A method of assembling a pressure sensor, comprising:
attaching a sensor adapter to a sensor body;
welding the sensor adapter to the sensor body;
hardening the attached and welded sensor body and sensor adapter;
applying one or more gauges to a portion of the sensor adapter;
enclosing the one or more gauges, the sensor body and the sensor adapter within a sensor cover;
adding one or more leads to the one or more gauges;
potting the one or more leads and the one or more gauges within the sensor cover;
attaching the one or more leads to an output connector; and
securing the output connector to the sensor cover.

12. The method of assembling a pressure sensor of claim 11, wherein attaching the sensor adapter to the sensor body includes screwing the sensor adapter to the sensor body.

13. The method of assembling a pressure sensor of claim 12, wherein the sensor adapter and the sensor body are screwed at a torque between 40 to 50 lb-ft.

14. The method of assembling a pressure sensor of claim 11, wherein the welding includes laser welding.

15. The method of assembling a pressure sensor of claim 11, wherein the hardening includes heat treating the sensor adapter and the sensor body at a temperature ranging from 800 to 1000 degrees Fahrenheit for between 2 and 4 hours.

16. The method of assembling a pressure sensor of claim 11, wherein the output connector is secured to the sensor cover with one or more set screws.

17. The method of assembling a pressure sensor of claim 11, further comprising inserting an input port adapter into the sensor adapter to change a size of an input port of the pressure sensor.

18. The method of assembling a pressure sensor of claim 11, wherein the one or more gauges includes a strain gauge.

19. The method of assembling a pressure sensor of claim 11, wherein the potting includes a potting material comprising padding or insulation for the one or more gauges.

20. The method of assembling a pressure sensor of claim 11, further comprising bonding the one or more gauges to a sensor tube sidewall of the sensor adapter, or the one or more gauges are bonded to a diaphragm at the sensor adapter.
